(19) United States
(12) Patent Application Publication
(10) Pub. No.: US 2026/0031582 A1
(43) Pub. Date: Jan. 29, 2026

(54) MICRO HIGH-FREQUENCY RF CONNECTOR RECEPTACLE, CONNECTOR AND ASSEMBLY METHOD

(71) Applicant: Amphenol-Kai Jack (Shenzhen) Inc., Guangdong, Guangdong (CN)

(72) Inventors: Owen R. Barthelmes, Putnam Valley, NY (US); Zhu LIWEI, Guangdong, Guangdong (CN)

(21) Appl. No.: 18/995,367

(22) PCT Filed: Jul. 20, 2023
(86) PCT No.: PCT/US2023/028256

§ 371 Date: Jan. 16, 2025

(30) Foreign Application Priority Data
Jul. 20, 2022 (CN) 202210858143.0

(51) Int. Cl. H01R 24/44; H01R 9/05; H01R 13/405; H01R 13/506; H01R 43/16; H01R 43/24; H01R 103/00

(52) U.S. Cl. CPC H01R 24/44; H01R 9/0518; H01R 13/405; H01R 13/506; H01R 43/16; H01R 43/24; H01R 2103/00; H01R 2201/26

(57) ABSTRACT

Micro high-frequency RF connector receptacles and related components are described. The receptables include an outer conductor having integrally molded first and second outer bodies, an insulator arranged inside the outer conductor and having first and second insulation bodies, a linear inner conductor having integrally molded first and second inner bodies, and a sleeve sleeved over the outer conductor and configured to cover a protection layer of a cable. Methods of assembling such receptacles and connectors associated therewith are described.

### CROSS REFERENCE TO RELATED APPLICATIONS

This application claims the benefit of CN Application No. 202210858143.0, filed on Jul. 20, 2022, which is incorporated herein by reference in its entirety.

### FIELD OF THE INVENTION

The present invention relates to the field of connectors, and specifically, to a micro high-frequency radio frequency (RF) connector receptacle and an assembly method therefor.

### BACKGROUND OF THE INVENTION

Subminiature push-on (SMP) connectors can achieve high shielding and very small interconnects, and are often used for miniaturized high-frequency coaxial modules and high data rate applications, such as antennas, broadband installation, testing and measurement, and quantum computing.

Referring to FIG. 16 and FIG. 17, the structure of a receptacle of a conventional SMP connector generally includes an outer conductor 3′, an inner conductor 1′, and an insulator 2′ formed by a housing and a main body, wherein the inner conductor 1′ is connected with a core of a cable 5′ by means of welding, which not only is disadvantageous to automated production and inefficient in assembly, but also requires an additional cover 8′ so as to facilitate welding. The cover 8′ typically has little interference and is easy to loosen and fall off when used in a vibrating environment. Consequently, the inner conductor may become exposed to the air, leading to signal leakage or even a short circuit of an electrical connection provided thereby. In order to address the short circuit problem, a disc insulator 7′ may be added between the inner conductor 1′ and the cover 8′. There is a risk that the part may not be properly assembled, and moreover, it may be difficult to detect the missing part (disc insulator 7′) after assembly.

In addition, in order to improve reliability of a connection provided by the SMP connector, a grounding elastic sheet may be provided on the outer conductor 3′, which not only increases the cost, but also has higher requirements on the assembled cavity so that the grounding elastic sheet is reliably grounded. This all may result in a design difficulty that has increased difficulty for a customer or end-user. Additionally, inclusion of such grounding elastic sheet may reduce the available internal space of the device. As a result, the connector may be relatively large in volume or space, and the customer/end-user must consider the requirement for a large assembly space when using the connector.

### SUMMARY OF THE INVENTION

In view of the above, and the following description, embodiments of the present disclosure are directed to a micro high-frequency RF connector receptacle and an assembly method therefor.

In accordance with some embodiments, a micro high-frequency RF connector receptacle is provided. The micro high-frequency RF connector receptacle includes an outer conductor that is L-shaped that includes a first outer body and a second outer body that are integrally molded. The first outer body is molded through a stamping and rounding process for electrical connection with a plug and the second outer body is curled to hold a shielding layer of a cable. An insulator that is L-shaped is arranged inside the outer conductor and includes a first insulation body and a second insulation body that are integrally injection molded. The first insulation body includes a first through hole extending axially and the second insulation body is molded on a top end of the first insulation body and includes a semi-open first accommodating groove and a first insulation back cover, and the first accommodating groove is configured to wrap an insulation layer of the cable. An inner conductor that is linear includes a first inner body and a second inner body that are integrally molded. The first inner body is molded through a stamping and rounding process for electrical connection with a plug and is arranged inside the first through hole and the second inner body is curled to hold a bent core of the cable. A sleeve that is L-shaped is sleeved on the outer conductor and a protection layer of the cable.

In addition to one or more of the features described above, or as an alternative, further embodiments of the receptables may include that the outer conductor is made by cutting a material strip from an outer conductor intermediate structure. The outer conductor intermediate structure includes an outer conductor material strip molded in a continuous mold and an outer molded body arranged at one side of the outer conductor material strip. Several second outer elastic sheets extend outwardly from two sides of one end of the outer molded body that is close to the outer conductor material strip to obtain the second outer body. The other end of the outer molded body is integrally formed with the first outer body and several first outer elastic sheets are arranged on one end of the first outer body that is away from the second outer body.

In addition to one or more of the features described above, or as an alternative, further embodiments of the receptables may include that an insulator groove is formed circumferentially on the top external circumference of the first insulation body, and the second insulation body is arranged to extend in a direction perpendicular to the extending direction of the first insulation body.

In addition to one or more of the features described above, or as an alternative, further embodiments of the receptables may include that the first through hole comprises a first hole segment and a second hole segment that are vertically arranged, the first hole segment being arranged to correspond to the insulator groove, and the inner diameter of the first hole segment is greater than the inner diameter of the second hole segment.

In addition to one or more of the features described above, or as an alternative, further embodiments of the receptables may include that the first insulation back cover comprises a back cover bending part and a back cover body part. The back cover bending part is integrally molded on the top end of the first insulation body and the back cover body part covers the first accommodating groove. The thickness of the back cover bending part is smaller than the thickness of the back cover body part.

In addition to one or more of the features described above, or as an alternative, further embodiments of the receptables may include that the inner conductor is made by cutting a material strip from an inner conductor intermediate structure, and the inner conductor intermediate structure comprises an inner conductor material strip molded in a continuous mold and an inner molded body arranged at one side of the inner conductor material strip. First inner elastic sheets extend outwardly from two sides of one end of the inner molded body that is close to the inner conductor material strip. The second inner body is formed by curling the first inner elastic sheets. The other end of the inner molded body is integrally formed with the first inner body. One end of the inner molded body away from the first inner body abuts the back cover body part.

In addition to one or more of the features described above, or as an alternative, further embodiments of the receptables may include that the sleeve is made by cutting a material strip from a sleeve intermediate structure. The sleeve intermediate structure includes a sleeve material strip molded in a continuous mold and a C-shaped sleeve body. The sleeve body includes a first sleeving segment, a second sleeving segment, a connecting segment, and a third sleeving segment that are sequentially arranged. The first sleeving segment is curled and bent to press tightly on the outside of the protection layer of the cable. The second sleeving segment is curled and bent to wrap the outside of the second outer body. The connecting segment wraps part of the second insulation body. The third sleeving segment is bent by 90° with respect to the connecting segment to wrap the outside of the first outer body.

In addition to one or more of the features described above, or as an alternative, further embodiments of the receptables may include that the third sleeving segment is connected to the connecting segment via a reinforcing segment, and the reinforcing segment is plate-shaped and is formed by bending one end of the connecting segment by 90°. A reinforcing sheet extends toward the reinforcing segment from one end surface of the connecting segment that is close to the reinforcing segment and the reinforcing sheet is flanged and arranged at the external surface of the reinforcing segment.

In addition to one or more of the features described above, or as an alternative, further embodiments of the receptables may include that the reinforcing sheet includes a reinforcing sheet body and a fixing segment extending at one end of the reinforcing sheet body.

In accordance with some embodiments, assembly methods for a micro high-frequency RF connector receptacle similar to that described above are provided. The methods of assembly include preparing an outer conductor and an insulator, so that a second outer body of the outer conductor is not curled, and a first insulation back cover of the insulator does not cover a first accommodating groove; assembling the insulator into the first outer body; connecting the inner conductor with a core of a cable and then installing the same inside a first through hole of the insulator; bending the cable so that it is placed inside the first accommodating groove, and bending the first insulation back cover so that it covers an insulation layer of the cable; and wrapping a sleeve over the outer conductor and crimping and fixing the same with a protection layer of the cable.

In accordance with some embodiments, a connector is provided. The connector includes a plug and a receptacle that are paired, and the receptacle is similar to the above-described micro high-frequency RF connector receptacle. The plug includes a plug inner conductor and a plug outer conductor that are molded in a continuous mold, as well as a plug insulator that is integrally injection molded. The plug insulator is molded on an outer wall of the plug outer conductor. When the plug is paired with the receptacle, the plug inner conductor is inserted into the first inner body and electrically connected with the first inner body and the first outer body is inserted into the plug outer conductor and electrically connected with the plug outer conductor.

In addition to one or more of the features described above, or as an alternative, further embodiments of the connectors may include a locking groove formed circumferentially on the peripheral wall of the plug insulator. The receptacle may further include an L-shaped housing assembly that sleeves over the sleeve, and the housing assembly includes a housing body and a housing snap-fit plate for sliding snap-fit connection at an opening part of the housing body. A locking sliding groove is formed axially on both sides of the opening part of the housing body, and one end of the locking sliding groove is formed with a pre-locking hole and a secondary locking hole that are arranged at an interval. A first part of the housing snap-fit plate includes a locking edge that extends axially, and a locking protrusion extends outwardly from one end of the locking edge. The bottom end of a second part of the housing snap-fit plate is provided with a locking buckle. In a pre-locking state, the locking protrusion is fit into the pre-locking hole, and the plug can be flexibly connected to the receptacle and in a secondary locking state, the locking protrusion is fit into the secondary locking hole, the locking buckle is in buckle connection with the locking groove, and the plug is in locked connection with the receptacle.

Compared to conventional configurations or the like, the micro high-frequency RF connector receptacles, the assembly methods therefor, and the connectors according to embodiments of the present disclosure may provide a variety of benefits and/or advantages, including, without limitation, the following.

In accordance with some embodiments, the connector receptacle includes an inner conductor, an outer conductor, and a sleeve, as well as an insulator that is integrally injection molded, which not only simplifies the number of parts, avoids the risk of missing parts, and saves the manufacturing cost, but also is more conducive to realizing automated production as a production mode with feeding through a carrying belt and rolling is adopted for the inner conductor, the outer conductor, and the sleeve.

In accordance with some embodiments, the design of various part structures not only can realize signal transmission with higher performance and high reliability, but also leads to a simple assembly method, which improves an assembly efficiency.

In accordance with some embodiments, welding is not needed between the inner conductor and the cable core, which lowers the requirement for the internal space of the connector, so that the overall height is lower, thereby providing more available space for a wiring system or the like.

In accordance with some embodiments, a secondary locking structure can provide a reliable connection with and convenient separation from a plug.

### BRIEF DESCRIPTION OF THE DRAWINGS

FIG. 1 is a schematic diagram of an overall structure of an embodiment of the present disclosure;

FIG. 2 is a schematic cross-sectional view of the structure of FIG. 1;

FIG. 3 is a schematic structural diagram of an inner conductor according to an embodiment of the present disclosure;

FIG. 4 is a schematic structural diagram of an outer conductor according to an embodiment of the present disclosure;

FIG. 5 is a schematic diagram of the structure of an insulator according to an embodiment of the present disclosure;

FIG. 6 is a cross-sectional view of the insulator of FIG. 5, in a covered state;

FIG. 7 is a cross-sectional view of the insulator of FIG. 5 in an uncovered state;

FIG. 8 is a schematic diagram of a structure of a sleeve according to an embodiment of the present disclosure;

FIG. 9 is a schematic diagram of an outer conductor intermediate structure according to an embodiment of the present disclosure;

FIG. 10 is a schematic diagram of an inner conductor intermediate structure according to an embodiment of the present disclosure;

FIG. 11 is a schematic diagram of a sleeve intermediate structure according to an embodiment of the present disclosure;

FIG. 12 is a schematic diagram of a sleeve in accordance with an embodiment of the present disclosure;

FIG. 13 is a schematic diagram of a structure of a housing assembly in accordance with an embodiment of the present disclosure;

FIG. 14 is a schematic diagram of a housing snap-fit in accordance with an embodiment of the present disclosure;

FIG. 15 is a schematic diagram illustrating when a plug is inserted into a receptacle in accordance with an embodiment of the present disclosure;

FIG. 16 is a schematic diagram of a receptacle according to the prior art; and

FIG. 17 is a cross-sectional view of the receptacle according to the prior art.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be illustrative and explanatory in nature and non-limiting.

### DETAILED DESCRIPTION OF THE EMBODIMENT

Embodiments and technical solutions of the present disclosure will be described below with reference to the accompanying drawings.

In accordance with some embodiments of the present disclosure, a micro high-frequency RF connector receptacle is provided. The micro high-frequency RF connector receptacle may have a small number of parts as compared to prior configurations. Further, such parts may be manufactured using relatively simple molding processes, thus providing additional benefits over prior configurations. Accordingly, and in accordance with some embodiments, a fully automated production can be realized. Further, in accordance with some embodiments, the assembly of the parts may become relative simple and more reliable as compared to prior configurations. In addition, receptacles according to embodiments of the present disclosure can have a lower height and can further meet requirements of customers/end-users when compared to prior configurations of such receptacles.

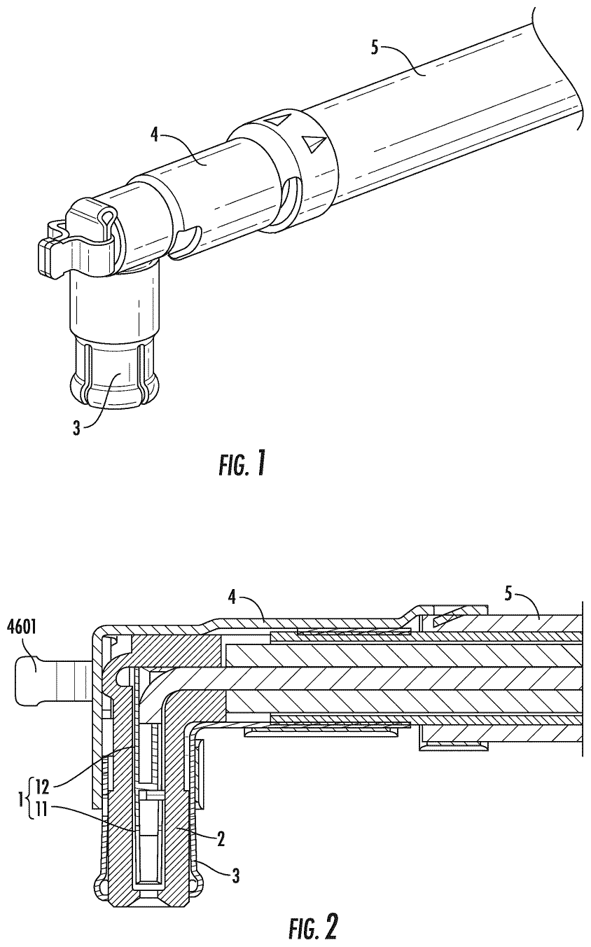

As shown in FIG. 1 and FIG. 2, a receptacle according to an embodiment of the present disclosure may include an outer conductor 3, an insulator 2 that is arranged inside the outer conductor 3, an inner conductor 1 that is arranged inside the insulator 2, and a sleeve 4 that is sleeved on the outer conductor 3. The outer conductor 3, the inner conductor 1, and the sleeve 4 may all be molded in a continuous mold, and the insulator 2 may be integrally injection molded.

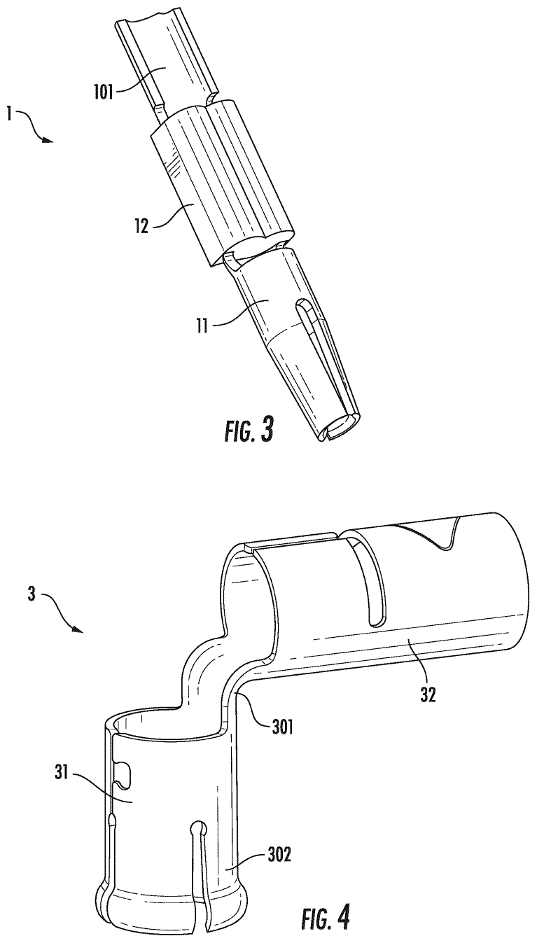

In accordance with some embodiments, one end of the inner conductor 1 may be electrically connected with a core of a cable by means of a crimp connection, and the other end may be inserted into an end of a plug. As shown in FIG. 3, the inner conductor may be a linear structure and may include, as shown, a first inner body 11 and a second inner body 12 that are integrally molded. The first inner body 11 may be molded through a stamping and rounding process to have an insertion hole for a plug end to be inserted. In accordance with some embodiments, and to realize a reliable connection, the first inner body 11 may be designed to have a narrowed opening and define a clamping opening having two or more spring arms. The second inner body 12 is formed by curling first inner elastic sheets 102 extending from two sides of the inner molded body 101 (e.g., as shown in FIGS. 3 and 10). For example, the inner conductor 1 may be made by cutting a material strip from an inner conductor intermediate structure 10 (e.g., as shown in FIG. 10). The inner conductor intermediate structure 10 includes an inner conductor material strip 100 molded in a continuous mold and the inner molded body 101 is arranged at one side of the inner conductor material strip 100. The first inner elastic sheets 102 extend outwardly from two sides of one end of the inner molded body 101 (e.g., at a side that is close to the inner conductor material strip 100), and the second inner body 12 may be formed by curling the first inner elastic sheets 102 with the other end of the inner molded body 101 being integrally formed with the first inner body 11.

In accordance with some embodiments, the top end of the inner molded body 101 and the bottom end of the second inner body 12 can abut inside the insulator 2. This may result in a firm axial positioning and may reduce or avoid a disconnection risk caused by axial movement of the inner conductor 1.

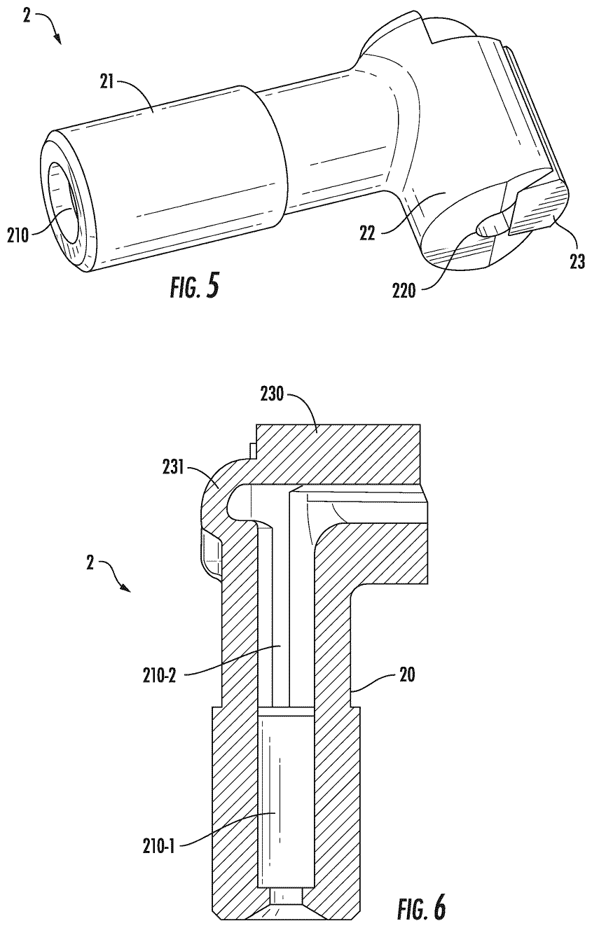

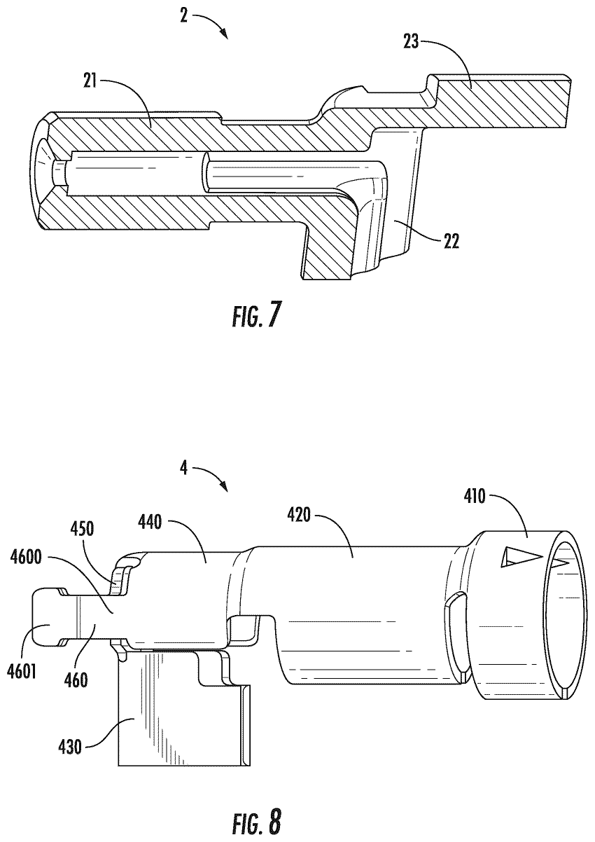

Referring to FIG. 5, FIG. 6, and FIG. 7, as shown, the insulator 2 may be substantially L-shaped. The insulator 2 includes a first insulation body 21 and a second insulation body 22 that are integrally injection molded. In accordance with some embodiments, the first insulation body 21 and the second insulation body 22 extend in a vertical or axial direction. The first insulation body 21 includes a first through hole 210 extending axially therethrough. The second insulation body 22 is molded on a top end of the first insulation body 21 and includes a semi-open first accommodating groove 220. The second insultation body 22 may include a first insulation back cover 23 that is integrally molded on the first insulation body 21 and used for covering the first accommodating groove 220. The inner conductor 1 may be accommodated inside the first through hole 210 and a cable may be accommodated inside the first accommodating groove 220. Because the inner conductor 1 is a linear structural, a core of the cable may be connected to the second inner body 12 of the inner conductor 1, and then the cable may be covered inside the first accommodating groove 220 by bending of the cable. In accordance with some embodiments, the second insulation body 22 can wrap an insulation layer of the cable.

As shown in FIG. 6, the first through hole 210 may be divided into a first hole segment 210-1 and a second hole segment 210-2 that are vertically or axially arranged. That is, the first hold segment 210-1 and the second hole segment 210-2 may define a continuous passage through a portion of the insulator 2. In accordance with some embodiments, an inner diameter of the first hole segment 210-1 may be greater than an inner diameter of the second hole segment 210-2. That is, in some embodiments, the first through hole 210 is arranged as a stepped hole or passage with variable or changing dimensions (e.g., diameter of the hole). When the inner conductor 1 is placed inside the first through hole 210, the bottom end of the second inner body 12 abuts on a step, shelf, shoulder, or the like between the second hole segment 210-2 and the first hole segment 210-1 (e.g., at the transition from one diameter hole to the next). Further, the top end of the inner molded body 201 may abut on the first insulation back cover 23, thereby achieving an axial stability of the inner conductor 1.

In accordance with some embodiments, and as shown in FIG. 6, an insulator groove 20 is formed or defined circumferentially on a top external circumference of the first insulation body 21. In some such configurations, an end (e.g., interior end) of the first hole segment 210-1 may be arranged to correspond to the insulator groove 20. As such, a stepped design may be formed or defined both on the peripheral or exterior surface of the first insulation body 21 and on the interior defining the first through hole 210. As a result of this stepped design, high-performance impedance matching can be achieved while realizing miniaturization. The second insulation body 22 may be arranged to extend in a direction perpendicular to the extending (axial) direction of the first insulation body 21 to form an L-shaped structure. The L-shaped structure of the insulator 2 can provide an anti-rotation function. Furthermore, the assembly of the inner conductor 1 may become simpler and more reliable through the semi-open first accommodating groove 220 and the first insulation back cover 23 that covers it.

As shown in FIGS. 5-6, the first insulation back cover 23 includes a back cover bending part 231 and a back cover body part 230. The back cover bending part 231 may be integrally molded on a top end of the first insulation body 21, and the back cover body part 230 may cover the first accommodating groove 220. A thickness (e.g., material thickness) of the back cover bending part 231 may be smaller or thinner than a thickness of the back cover body part 230 and/or a wall thickness of the first hole segment 210-1.

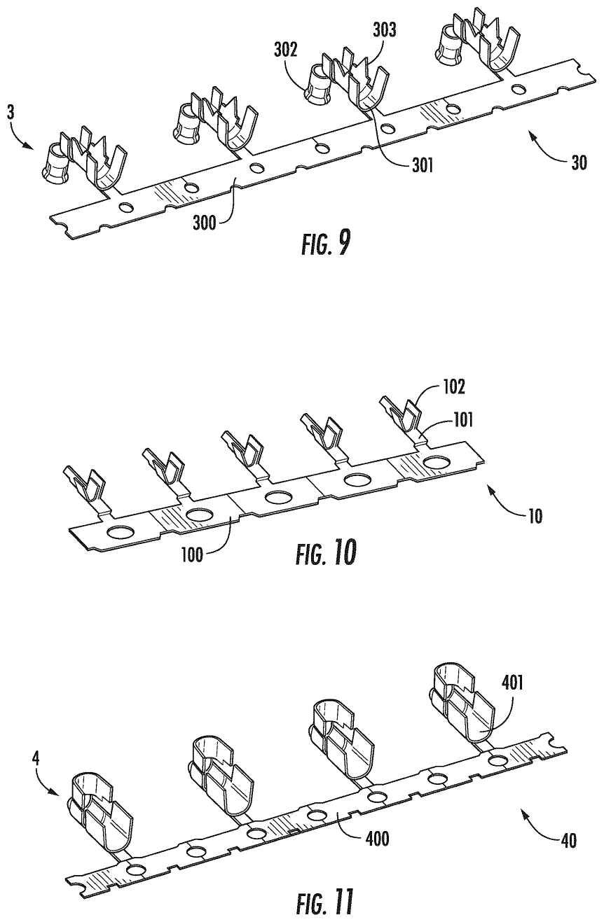

Referring to FIG. 4 and FIG. 9, as shown in this non-limiting configuration, the outer conductor 3 is L-shaped and may be molded in a continuous mold. The insulator 2 may be arranged within the outer conductor 3. As shown, the outer conductor 3 may include a first outer body 31 and a second outer body 32 that are integrally molded. The first outer body 31 may be molded through a stamping and rounding process for electrical connection with a plug and the second outer body 32 may be curled to hold a shielding layer of a cable. For example, the outer conductor 3 may be made by cutting a material strip from an outer conductor intermediate structure 30 (FIG. 9). The outer conductor intermediate structure 30, as shown in FIG. 9, includes an outer conductor material strip 300 molded in a continuous mold and an outer molded body 301 arranged at one side of the outer conductor material strip 300. Several second outer elastic sheets 303 extend outwardly from two sides of one end of the outer molded body 301 that is close to the outer conductor material strip 300 to form the second outer body 32. The other end of the outer molded body 301 may be integrally formed with the first outer body 31, and several first outer elastic sheets 302 may be arranged on one end of the first outer body 31 that is away from the second outer body 32. During assembly, the first outer body 31 is rounded first, while the second outer elastic sheets 303 are not yet curled and bent. The first insulation body 21 of the insulator 2 is placed into the first outer body 31 from above, and the second insulation body 22 can also be easily put in place. After the inner conductor 1 is connected to a cable and is placed inside the insulator 2, the second outer elastic sheets 303 may then be curled so that they wrap and are in crimp connection with a shielding layer of the cable.

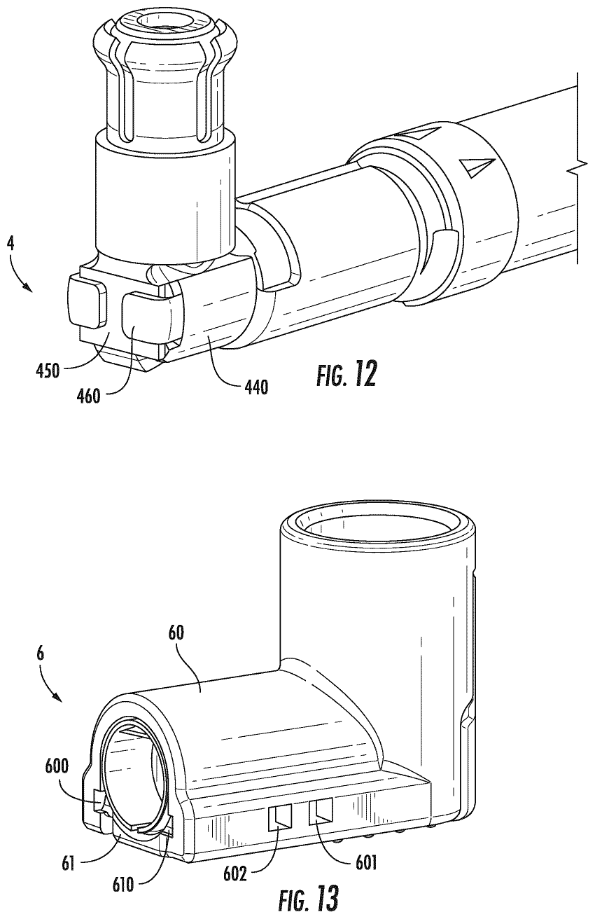

Referring to FIG. 8, FIG. 11, and FIG. 12, the sleeve 4 may also be L-shaped and may be sleeved on the outer conductor 3 and a protection layer of a cable. The sleeve 4 may be molded in a continuous mold. The sleeve 4 may be made by cutting a material strip from a sleeve intermediate structure 40 (FIG. 11), the sleeve intermediate structure 40 includes a sleeve material strip 400 molded in a continuous mold and a C-shaped sleeve body 401. The sleeve body 401, as shown in FIG. 8, includes a first sleeving segment 410, a second sleeving segment 420, a connecting segment 440, and a third sleeving segment 430 that are sequentially arranged. The first sleeving segment 410 may be a curled and bent structure configured to press tightly on an outside of a protection layer of a cable. The second sleeving segment 420 may be a curled and bent structure configured to wrap an outside of the second outer body 32. The connecting segment 440 is configured to wrap part of the second insulation body 22. The third sleeving segment 430 may be configured as a bent structure bent at 90° with respect to the connecting segment 440 to wrap an outside of the first outer body 31. In accordance with some embodiments, to achieve better performance, the sleeve body 401 may wrap all connections on the outer conductor 3. That is, in the present embodiment and with reference to FIG. 8, all rounded or bent connections of various segments of the sleeve 4 are located at the bottom as illustrated, and correspondingly, all the connections of the outer conductor 3 are located at the top

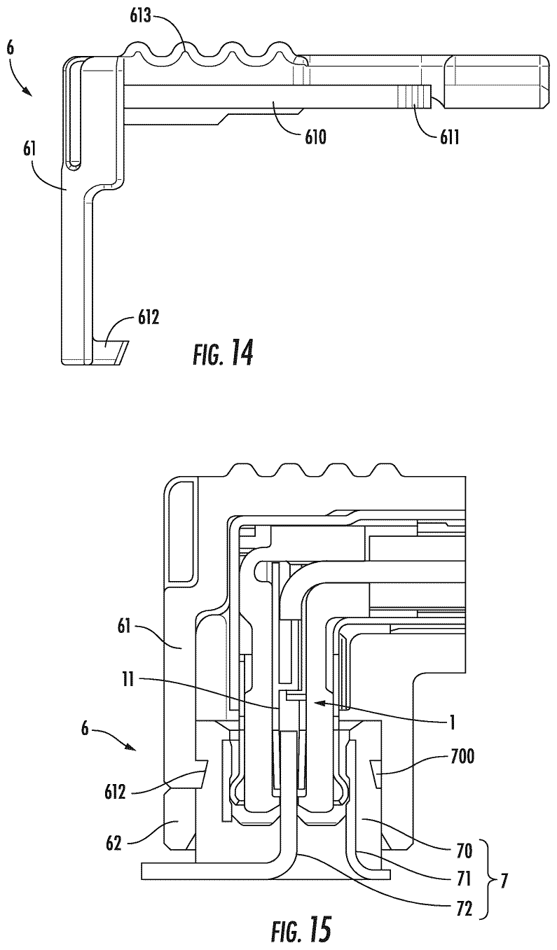

FIG. 8 and FIG. 12 show two types of sleeve structures of the sleeve 4 in accordance with embodiments of the present disclosure. As shown in FIG. 8, the third sleeving segment 430 is connected to the connecting segment 440 via a reinforcing segment 450. The reinforcing segment 450 may be a plate-shaped structure and is formed by bending one end of the connecting segment 440 by 90°. As shown in FIG. 12, a reinforcing sheet 460 extends toward the reinforcing segment 450 from one end surface of the connecting segment 440 that is close to the reinforcing segment 450. The reinforcing sheet 460 may be flanged and arranged at the external surface of the reinforcing segment 450. The structure shown in FIG. 12 can cause this receptacle to be fixed onto a housing assembly, thereby realizing more reliable assembly. The housing here uses an existing structure, or may use the structure shown in FIG. 13, FIG. 14, and FIG. 5. In the embodiment of FIG. 8, the reinforcing sheet 460 includes a reinforcing sheet body 4600 and a fixing segment 4601 extending at one end of the reinforcing sheet body 4600. The fixing segment 4600 extends in the axial direction of the connecting segment 440 while the reinforcing sheet body 4601 extends in a direction perpendicular thereto. The reinforcing sheet 460, having the structure shown in FIG. 8, can be used to fix and mount the receptacle without the need for a separate housing assembly.

Referring to FIGS. 13-15, embodiments of the present disclosure directed to a receptacle that uses a housing assembly are shown. The structures shown in FIGS. 13-15 are representative of an assembly housing 6 in accordance with a non-limiting embodiment. The housing assembly 6 comprises a housing body 60 and a housing snap-fit plate 61 in cooperation with each other. In this illustrative configuration, the housing body 60 and the housing snap-fit plate 61 are L-shaped. For ease of description, the part of the housing snap-fit plate 61 in FIG. 14 is referred to as a first part, while the part extending vertically is referred to as a second part, and correspondingly, the same description also applies to the housing body 60. As shown in FIG. 13, the housing body 60 sleeves over the assembled receptacle, that is, sleeved over the sleeve 4. An opening part is formed above the first part of the housing body 60, the opening part runs axially through the top surface of the first part and partially extends to the external side surface of the second part. A locking edge 610 extends axially on two sides of the housing snap-fit plate 61, and correspondingly, a locking sliding groove 600 is formed on a side surface of the opening part. In accordance with some embodiments, the cross section of the locking sliding groove may be rectangular or a T-shaped groove for achieving a more stable sliding engagement, although other shapes may be employed without departing from the scope of the present disclosure. The housing snap-fit plate 61 is configured to slide along the locking sliding groove 600 on one side of the second part of the housing body 60, which enables switching between two locking states, such as pre-locking and secondary locking.

In accordance with some embodiments, one end of the locking sliding groove 600 of the housing body 60 that is away from its second part is sequentially formed with a pre-locking hole 601 and a secondary locking hole 602. To engage therewith, a locking protrusion 611 extends outwardly from one end of the locking edge 610. When the locking protrusion 611 is configured to be inside or engage with the pre-locking hole 601, the housing assembly 6 is in a pre-locking state, and the free assembly of the plug 7 and the receptacle can be realized at this moment. When the locking protrusion 611 is configured to be inside or engage with the secondary locking hole 602, the housing snap-fit plate 61 can be in buckle connection with the plug 7, such that the plug and the receptacle are in a locked state. In accordance with some embodiments, a window may be formed or provided at a bottom part of the second part of the housing body 60, such that the housing snap-fit plate 61 can run through the window for buckle connection with the plug.

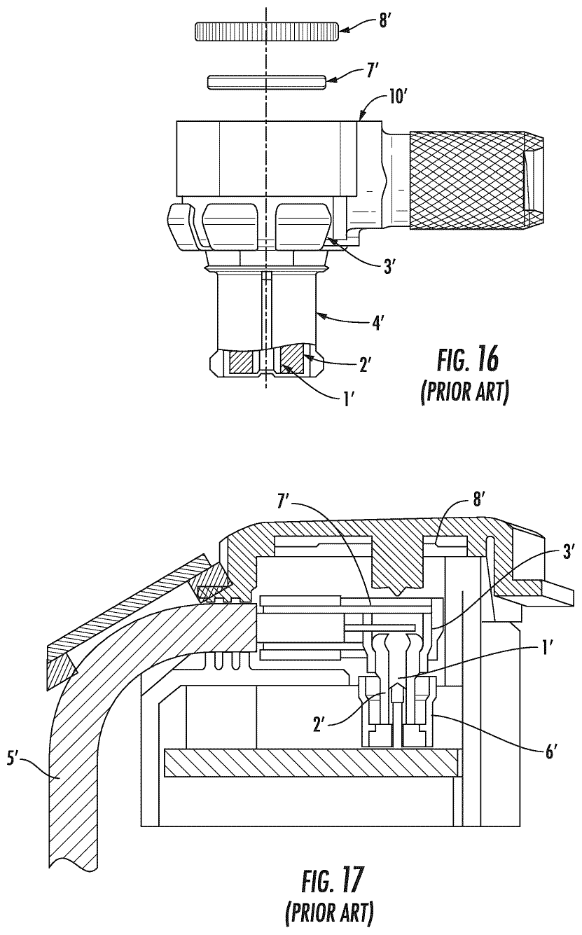

FIG. 15 is a schematic diagram illustrating the plug 7 and the receptacle in a locked state or engaged state. In accordance with some embodiments, a connector comprising a plug 7 and a receptacle that are in locked connection through the housing assembly 6 are provided, as illustrated in FIG. 15. In such configurations, the receptacle may adopt or incorporate the above-described receptacle structure or variations thereon. The plug may be arranged having a plug inner conductor 72 and a plug outer conductor 71 that are molded in a continuous mold, as well as a plug insulator 70 that is integrally injection molded. The plug insulator 70 is configured to wrap the plug inner conductor 72 and the plug outer conductor 71 therein to form an integral piece. When the plug 7 is paired with the receptacle, the plug inner conductor 72 is inserted into the first inner body 11 and electrically connected with the first inner body 11 of the inner conductor 1 through the first through hole 210 of the insulator 2. A reliable electrical connection may be provided between the plug outer conductor 71 and the first outer elastic sheets 302 of the outer conductor 3. A reliable connection with the receptacle may be provided using a locking groove 700 that is formed circumferentially on a peripheral wall of the plug insulator 70, and when in the secondary locking state, a buckle connection is made between the locking buckle 612 and the locking groove 700.

In accordance with some embodiments of the present disclosure, assembly methods for assembling the above-described micro high-frequency RF connector receptacle are provided. The method of assembly comprises a series of steps, with reference made to the above described embodiments and reference to the figures thereof.

As a first step, the outer conductor 3, the inner conductor 1, and the sleeve 4 are molded in a continuous mold. The insulator 2 is formed through integral injection molding. The corresponding molded structure before the assembly is: the second outer body 32 of the outer conductor 3 is not curled; the first insulation back cover 23 of the insulator 2 does not cover the first accommodating groove 220; and none of the elastic sheets of all segments of the sleeve 4 is rounded or curled.

Next, the insulator 2 is assembled into the first outer body 31. Next, the inner conductor 1 is connected with the core of a cable and installed inside the first through hole 210 of the insulator 2. The cable is bent so that it is placed inside the first accommodating groove 220. The first insulation back cover 23 is bent so that it covers the insulation layer of the cable. The second outer body is curled such that it is in crimp connection with the shielding layer of the cable.

Next, the sleeve 4 is wrapped over the outer conductor 3. The sleeve 4 is then crimped and fixed with the protection layer of the cable.

Finally, as an optional step, assembly of the combination of components is performed such that the assembly is installed into a housing assembly as needed. Then assembly is then paired with a corresponding plug. When the pairing with the plug is completed, the housing assembly may be switched from a pre-locking state to a secondary locking state by means of the anti-sliding protrusion 613 on the housing snap-fit plate 61, thereby achieving the reliable assembly of the plug and the receptacle.

The above described micro high-frequency radio frequency (RF) connectors, receptacles, components, and methods of assembly thereof may be used for a variety of purposes, applications, and within a variety of industries. For example, and without limitation, the disclosed configurations may be used in the automobile industry for data transfer, communication, and the like. In some configurations, the connectors and associated components disclosed herein may be used for cameras onboard automobiles. In some configurations, embodiments of the present disclosure may be used for data connections onboard automobiles. In accordance with some embodiments, the disclosed configurations may be used for farming equipment and/or robotic equipment (e.g., imaging, sensor data transmission, etc.). In some embodiments, the connectors and other components disclosed herein may be used in devices for wireless communication (e.g., 5G, Wi-Fi, Zigbee, etc.), such as modems and the like. Those of skill in the art will appreciate that the disclosed embodiments and variations thereon may be used for any RF connector applications, and thus the disclosed embodiments are not intended to be limiting to any specific or particular use and/or application thereof.

The above description merely contains embodiments of the present invention, which are not intended to limit the patent scope of the present invention. Any equivalent structure or equivalent flow change made according to the description and the accompanying drawings of the present invention, or direct or indirect applications in other related technical fields, shall be encompassed by the patent protection scope of the present invention.

As used herein, the terms “about” and “substantially” are intended to include the degree of error associated with measurement of the particular quantity based upon the equipment available at the time of filing the application. For example, “about” can include a range of ±8% or 5%, or 2% of a given value. Similarly, “substantially” captures the concept of non-perfect or non-ideal, and thus allows for acceptable deviations that are suitable for a given feature and as understood by those of skill in the art to be acceptable. The terms “at least one” and “one or more” are understood to include any integer number greater than or equal to one, i.e., one, two, three, four, etc. The term “a plurality” is understood to include any integer number greater than or equal to two, i.e., two, three, four, five, etc. The term “connection” can include an indirect “connection” and a direct “connection”.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that embodiments of the present disclosure may include only some of the described aspects and features. Accordingly, the disclosure is not to be seen as limited by the foregoing description but is only limited by the scope of the appended claims.

What is claimed is:

1. A micro high-frequency radio frequency (RF) connector receptacle, the receptable comprising:
an L-shaped outer conductor, the outer conductor comprising a first outer body and a second outer body that are integrally molded, wherein the first outer body is molded through a stamping and rounding process for electrical connection with a plug and the second outer body is configured to hold a shielding layer of a cable;
an L-shaped insulator arranged inside the outer conductor, the insulator comprising a first insulation body and a second insulation body that are integrally injection molded, wherein the first insulation body comprises a first through hole extending in an axial direction, the second insulation body being molded on a top end of the first insulation body and comprising a semi-open first accommodating groove and a first insulation back cover that is integrally molded on the first insulation body and configured to cover the first accommodating groove, and the first accommodating groove is configured to wrap an insulation layer of the cable;
a linear inner conductor comprising a first inner body and a second inner body that are integrally molded, wherein the first inner body is molded through a stamping and rounding process for electrical connection with a plug, and wherein the first inner body is arranged inside the first through hole and the second inner body is configured to hold a bent core of the cable; and
an L-shaped sleeve sleeved over the outer conductor and configured to cover a protection layer of the cable.

2. The micro high-frequency RF connector receptacle according to claim 1, further comprising an outer conductor intermediate structure comprising the outer conductor, wherein the outer conductor is configured to be cut from the outer conductor intermediate structure, wherein the outer conductor intermediate structure comprises:
an outer conductor material strip molded in a continuous mold;
an outer molded body arranged at one side of the outer conductor material strip;
at least one second outer elastic sheet extends outwardly from each of two sides of one end of the outer molded body at a position close to the outer conductor material strip and configured to define the second outer body and the other end of the outer molded body is integrally formed with the first outer body of the outer conductor; and
at least one first outer elastic sheet arranged on one end of the first outer body at a position away from the second outer body.

3. The micro high-frequency RF connector receptacle according to claim 1, further comprising an insulator groove defined circumferentially on a top external circumference of the first insulation body, and the second insulation body is arranged to extend in a direction perpendicular to an extending direction of the first insulation body.

4. The micro high-frequency RF connector receptacle according to claim 3, wherein the first through hole comprises a first hole segment and a second hole segment that are vertically arranged, wherein the first hole segment is arranged to correspond to the insulator groove, and an inner diameter of the first hole segment is greater than an inner diameter of the second hole segment.

5. The micro high-frequency RF connector receptacle according to claim 4, wherein the first insulation back cover comprises a back cover bending part and a back cover body part, the back cover bending part integrally molded on the top end of the first insulation body, and the back cover body part covers the first accommodating groove; and the thickness of the back cover bending part is smaller than the thickness of the back cover body part.

6. The micro high-frequency RF connector receptacle according to claim 5, further comprising an inner conductor intermediate structure comprising the inner conductor, wherein the inner conductor is configured to be cut from the inner conductor intermediate structure, wherein the inner conductor intermediate structure comprises:
an inner conductor material strip molded in a continuous mold;
an inner molded body arranged at one side of the inner conductor material strip; and
at least one first inner elastic sheet extends outwardly from each of two sides of one end of the inner molded body at a position close to the inner conductor material strip and configured to define the second inner body and the other end of the inner molded body is integrally formed with the first inner body of the at least one inner conductor,
wherein one end of the inner molded body that is away from the first inner body abuts the back cover body part.

7. The micro high-frequency RF connector receptacle according to claim 1, further comprising a sleeve intermediate structure comprising the sleeve, wherein the sleeve is configured to be cut from the sleeve intermediate structure, wherein the sleeve intermediate structure comprises:
a sleeve material strip molded in a continuous mold and a C-shaped sleeve body;
wherein the sleeve body comprises a first sleeving segment, a second sleeving segment extending from the first sleeving segment, a connecting segment extending from the second sleeving segment, and a third sleeving segment extending from the connecting segment, and
wherein the first sleeving segment is configured to be curled and bent to press tightly on an outside of the protection layer of the cable, the second sleeving segment is configured to be curled and bent to wrap an outside of the second outer body, the connecting segment is configured to wrap a part of the second insulation body, and the third sleeving segment is oriented at 90° with respect to the connecting segment and configured to wrap an outside of the first outer body.

8. The micro high-frequency RF connector receptacle according to claim 7,
wherein the third sleeving segment is connected to the connecting segment via a reinforcing segment, and the reinforcing segment is plate-shaped and is formed by bending one end of the connecting segment by 90°; and
a reinforcing sheet extends toward the reinforcing segment from one end surface of the connecting segment that is close to the reinforcing segment, and the reinforcing sheet is flanged and arranged at an external surface of the reinforcing segment.

9. The micro high-frequency RF connector receptacle according to claim 8, wherein the reinforcing sheet comprises a reinforcing sheet body and a fixing segment extending at one end of the reinforcing sheet body.

10. The micro high-frequency RF connector receptacle according to claim 1, wherein the connector receptacle is configured for electrical connection between components on an automobile.

11. The micro high-frequency RF connector receptacle according to claim 1, wherein the connector receptacle is configured for electrical connection between components on farm equipment.

12. The micro high-frequency RF connector receptacle according to claim 1, wherein the connector receptacle is configured for electrical connection between components on a robotic assembly.

13. The micro high-frequency RF connector receptacle according to claim 1, wherein the connector receptacle is configured for electrical connection between components on a camera.

14. The micro high-frequency RF connector receptacle according to claim 13, wherein the camera is part of an automobile.

15. A connector comprising:
a plug; and
a receptacle, wherein the receptacle is a micro high-frequency RF connector receptacle according to claim 1;
wherein the plug comprises:
a plug inner conductor and a plug outer conductor that are molded in a continuous mold;
a plug insulator that is integrally injection molded on the outer wall of the plug outer conductor;
wherein, when the plug is connected with the receptacle, the plug inner conductor is inserted into and electrically connected with the first inner body and the first outer body is inserted into and electrically connected with the plug outer conductor.

16. The connector according to claim 15, wherein the plug insulator comprises a locking groove that is formed circumferentially on a peripheral wall of the plug insulator; the receptacle further comprises an L-shaped housing assembly that sleeves over the sleeve, and the housing assembly comprises a housing body and a housing snap-fit plate for sliding snap-fit connection at an opening part of the housing body.

17. The connector according to claim 16, wherein:
a locking sliding groove is formed axially on both sides of the opening part of the housing body, and one end of the locking sliding groove is formed with a pre-locking hole and a secondary locking hole that are arranged at an interval;
a first part of the housing snap-fit plate comprises a locking edge that extends in an axial direction;
a locking protrusion extends outwardly from one end of the locking edge; and
a bottom end of a second part of the housing snap-fit plate is provided with a locking buckle;
wherein in a pre-locking state, the locking protrusion is fit into the pre-locking hole, and the plug is flexibly connected to the receptacle; and
wherein in a secondary locking state, the locking protrusion is fit into the secondary locking hole, the locking buckle is in buckle connection with the locking groove, and the plug is in locked connection with the receptacle.

18. The connector according to claim 15, wherein the connector is configured for electrical connection between components on an automobile.

19. The connector according to claim 15, wherein the connector is configured for electrical connection between components on farm equipment.

20. The connector according to claim 15, wherein the connector is configured for electrical connection between components on a robotic assembly.

21. The connector according to claim 15, wherein the connector is configured for electrical connection between components on a camera.

22. The connector according to claim 21, wherein the camera is part of an automobile.

23. An assembly method for the micro high-frequency RF connector receptacle, the method comprising:
preparing an outer conductor, an insulator, an inner conductor, and a sleeve, so that a second outer body of the outer conductor is not curled, a first insulation back cover of the insulator does not cover a first accommodating groove, wherein the outer conductor, the inner conductor, and the sleeve are molded in a continuous mold, and the insulator is integrally injection molded;
assembling the insulator into a first outer body of the outer conductor;
connecting the inner conductor with a core of a cable, and installing the inner conductor inside a first through hole of the insulator;
bending the cable so that it is placed inside the first accommodating groove;
bending the first insulation back cover so that it covers an insulation layer of the cable;
curling the second outer body such that it holds a shielding layer of the cable;
wrapping the sleeve over the outer conductor; and
crimping and fixing the sleeve with a protection layer of the cable.

24. The method of claim 23, wherein the outer conductor is L-shaped, the insulator is L-shaped, and the inner conductor is linear.

25. The method of claim 23, further comprising integrally molding a first outer body and a second outer body to form the outer conductor.

26. The method of claim 25, wherein the first outer body of the outer conductor is formed by a stamping and rounding process.

27. The method of claim 23, further comprising integrally injection molding a first insultation body and a second insulation body to form the insulator.

28. The method of claim 23, further comprising integrally molding a first inner body and a second inner body to form the inner conductor.

29. The method of claim 23, wherein the first inner body of the inner conductor is formed by a stamping and rounding process.

30. The method of claim 23, wherein the outer conductor is obtained from an outer conductor intermediate structure and the inner conductor is obtained from an inner conductor intermediate structure, the method further comprising:
cutting a material strip from the outer conductor intermediate structure to obtain the outer conductor; and
cutting a material strip from the inner conductor intermediate structure to obtain the inner conductor.
